(19) United States
(12) Patent Application Publication
(10) Pub. No.: US 2002/0120541 A1
(43) Pub. Date: Aug. 29, 2002

(54) Methods and systems for a wash sale

(76) Inventors: Michael Mario D'Ambrosio, New Rochelle, NY (US); Michael George Brenish, Yonkers, NY (US)

Correspondence Address: John S. Beulick, Armstrong Teasdale LLP, Suite 2600, One Metropolitan Sq., St. Louis, MO, 63102, US

(21) Appl. No.: 09/794,866

(22) Filed: Feb. 27, 2001

(51) Int. Cl. G06F 17/60

(52) U.S. Cl. 705/36

(57) ABSTRACT

A method for tracking purchases and sales of securities to determine gains or losses on the securities using a wash sales system includes the steps of creating a database of securities purchases, adding sales of the securities to the database and comparing a sales date to a purchase date for each individual security. The system prepares a series of reports and determines character and timing of the deduction of a loss.

### BACKGROUND OF THE INVENTION

This invention relates generally to purchases and sales of securities and more specifically to, tax implications with respect to gains and losses from purchases and sales of securities.

The term “wash sale” as used herein refers to a series of transactions whereby the loss from the sale is deferred because the security was purchased within thirty days prior to or after the sale at a loss. Section 1091 of the Internal Revenue Code (26 U.S. Code § 1091), the so-called “wash sale” rules, precludes investors from claiming a federal income tax loss on the sale of stock or securities if the investor purchases (or has entered into a contract or option to purchase) substantially identical stock or securities within a period beginning 30 days before the date of the sale and ending 30 days after such date (the “61-day period”). If the amount of stock or securities purchased is greater than the amount of stock or securities sold, only the portion of the purchase that is not in excess of the sale is consider part of the wash sale transaction. Likewise, if the amount of stock or securities purchased is less than the amount of stock or securities sold only the portion of sale that is not excess of the purchase will be considered part of a wash sale transaction.

The wash sale rules apply to investors and traders disposing of stock or securities held as a capital asset, i.e., an asset that is not held in a dealer capacity. The wash sale rules apply not only to the investment activities of individual investors but also to the investment activities of regulated investment companies, popularly known as mutual funds. Mutual funds provide, among other benefits, provide individual investors with expert investment management services.

In general, gain or loss on the sale of a capital asset held for more than 12 months is long-term capital gain or loss. Gain or loss on the sale of a capital asset held for 12 months or less is short-term capital gain or loss. The amount of any loss disallowed under the wash sale rules is added to the taxpayer's cost base of the stock and securities purchased. In addition, the holding period of the stock and securities sold at loss is added to the holding period of the stock and securities purchased. When such purchased stock or securities are sold in a non-wash sale transaction, the deferred loss is realized by decreasing or increasing any realized gain or loss, respectively, from the purchased stock or security. Furthermore, the addition of the holding period of the stock and securities sold at a loss may change the character of the gain or loss from the sale of the purchased stock and securities from short-term to long-term.

In most cases, investors purchase a stock or security in many separate transactions. Each separate purchase is known as a “lot” or “layer.” For example, if Investor A purchases 600 shares of Company X stock on January 10^{th}, 300 shares on December 10^{th}, and 350 shares on December 15^{th}, Investor A would have purchased 1250 shares in three lots or layers. If on December 25^{th}, Investor A sells 450 shares of Company X stock at a loss, the loss would be disallowed for Federal income tax purposes because the sale, when coupled with the December purchases of the same stock, would have been a wash sale. The 450 shares sold on December 25^{th} would be matched with the 300 shares purchased on December 10^{th} and 150 of the 350 shares purchased on December 15^{th}. The deferred loss from the sale would be added to Investor A's cost base for the 300 shares purchased on December 10^{th} and 150 shares purchased on December 15^{th}. In addition, the holding period of the shares sold would be added to the holding period of the 300 shares purchased on December 10^{th} and 150 shares purchased on December 15^{th}.

Tracking incidences of wash sales is necessary for proper determination of tax liability, as no loss can be recognized for Federal income tax purposes on a security that is the subject of a wash sale.

While for a simple investor, such transactions are easy to track, asset management companies, for example, may participate in thousands of such transactions over the course of a fiscal year. Tracking of wash sales, can therefore be a complex and time consuming task, especially for companies who specialize in the buying and selling of stock and other securities.

It would be desirable to provide a method and a system with the capability to track the purchase of stock or other securities that are purchased within a specified timeframe of a sale, at a loss, of the same stock or security. It would be desirable to have the system and method track the purchased stocks and other securities until they are all completely sold. It would be still further desirable that such a system would provide an output that matches up the sales and purchases in a format that a user of the system could use to identify opportunities for wash sales so that they can be identified and preferably avoided.

### BRIEF SUMMARY OF THE INVENTION

The Wash Sales system described herein is configured to identify/ print records of securities sales whereby the loss from the sale of a security is deferred because the security was purchased within the 61-day period. The system, thus, precludes the user from erroneously claiming a loss that is nondeductible for tax purposes. The system is further configured to track those securities purchases causing the wash sales until they are sold in a transaction that is not itself a wash sale. The system, thus, permits the user to determine the correct time the loss arising from the sale of securities is deductible. The system is able to track for wash sales by creating a database of securities purchases, adding sales of the securities to the database and comparing a sales date to a purchase date for each individual security.

Initially, an external mainframe is used to run a transaction program that prepares a file of trades (buy and sale transactions) covering a user specified period that is then transferred to the wash sales system. For example, if a user wanted to identify wash sales occurring during the period Oct. 01, 1998 to Sep. 30, 1999, the user would account for the 61-day period by specifying the period from Sep. 1, 1998 to Oct. 30, 1999 in order to capture all wash sales arising during the review period.

After the wash sale system receives the trades file from the mainframe, it generates several reports, including a “wash sale review” report, an “expired and deferred wash sales” report, as well as, an “opening balance” report. The system further allows a user to change Committee for the Uniform Securities Practices (CUSIP) or lot numbers in the history table (i.e., the table containing the unexpired and deferred wash sales from prior year system reports). When such changes are requested, the system provides feedback as to the success or failure of the requested change.

The system also allows users to maintain a list of funds for which Wash Sales reports can be generated. This list is automatically copied to the external mainframe for use in determining which funds are included when the mainframe creates trades files.

### BRIEF DESCRIPTION OF THE DRAWINGS

FIG. 1 is a system diagram;

FIG. 2 is a network based system diagram;

FIG. 3 is a diagram showing options available to a wash sale system user;

FIG. 4 is an exemplary example of a user login screen;

FIG. 5 is an exemplary example of a main menu screen;

FIG. 6 is an exemplary example of a date range entry screen;

FIG. 7 is an exemplary example of a funds selection screen;

FIG. 8 is an exemplary example of a wash sales review report;

FIG. 9 is an exemplary example of an expired and deferred wash sales report;

FIG. 10 is an exemplary example of a opening balances report selection screen;

FIG. 11 is an exemplary example of a opening balances report;

FIG. 12 is an exemplary example of a change CUSIP number screen;

FIG. 13 is an exemplary example of a lot number changes screen; and

FIG. 14 is an exemplary example of a fund maintenance screen.

### DETAILED DESCRIPTION OF THE INVENTION

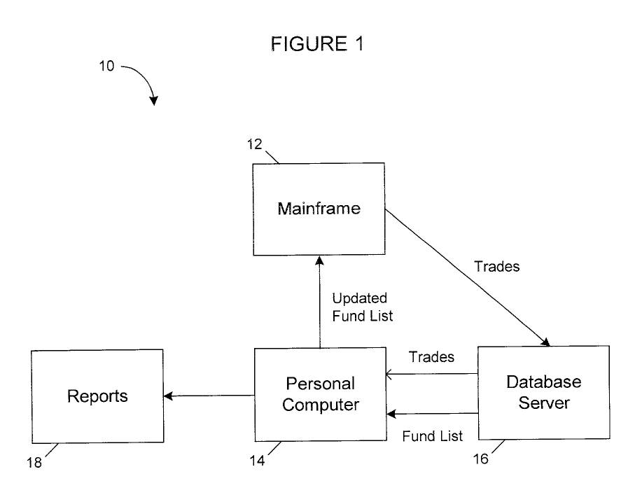

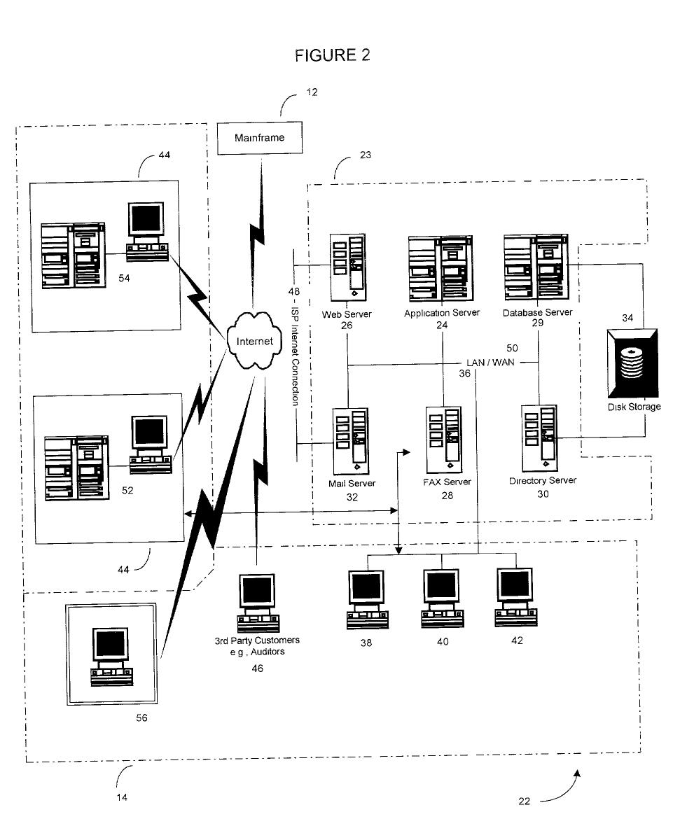

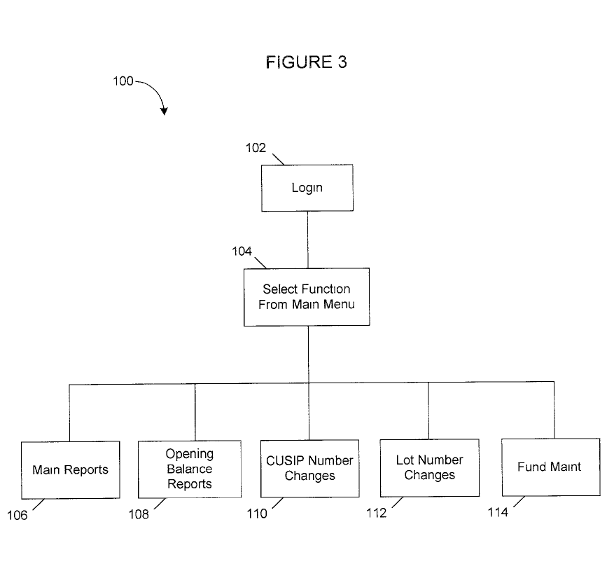

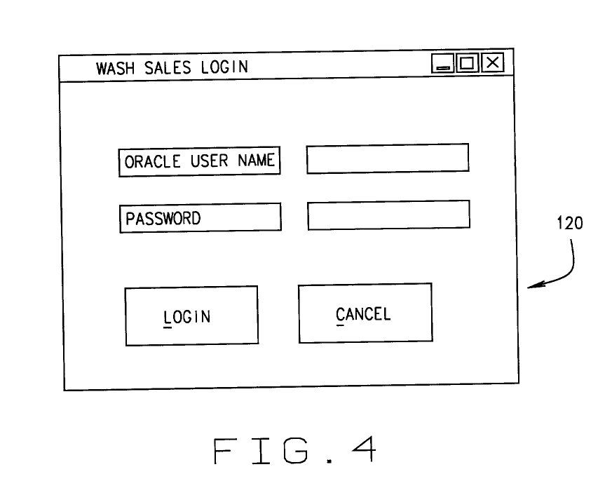

Set forth below is a description of exemplary methods and systems for facilitating tracking of wash sales. While the methods and systems are mostly described in the context of wash sales, the methods and systems are not limited to practice in connection with only wash sales tracking. The methods and systems can be used, for example, in connection with purchases and sales tracking for stocks, bonds and many other different types of securities. Included are details regarding exemplary hardware architectures (FIGS. 1 and 2), an exemplary process flowchart illustrating system functionality (FIG. 3), and exemplary screen shots (FIGS. 4-14) displayed by the exemplary system to a user desiring to facilitate wash sales. Although specific exemplary embodiments of methods and systems for accomplishing wash sales are described herein, the methods and systems are not limited to such specific exemplary embodiments.

Hardware Architecture

FIG. 1 is a block diagram of a system 10 that includes data flow for the tracking of wash sales. System 10 includes a mainframe 12 and a computer 14, both of which are interfaced to a database server 16. Mainframe 12 causes to be stored within a database (not shown) within database server 16 a list of all trades of stocks, etc. that have transpired. Computer 14 is configured to request from mainframe 12 trade activity, that is, purchases and sales of a selected group of securities (a fund list). Computer 14 receives the updated list of trade activities for selected funds from database server 16 based upon commands received from mainframe 12. Computer 14 is further configured to store the updated list within a database (not shown) within computer 14 and to compare sales and purchases of securities to determine existence of any wash sales. If wash sales are found to exist, computer is configured to present to the user reports 18 which detail the wash sales as described in detail below. In one embodiment, computer 14 and mainframe 12 are connected via a secure link for transfer of files describing trade activity. In an alternative embodiment, and as described below, computer 14 is one or more computers including a web browser, and mainframe 12 is accessible to computers 14 via a network such as an intranet or a wide area network such as the Internet. In an alternative embodiment, computers 14 are servers for a network of user devices.

As described above, in one embodiment, computers 14 are interconnected to a network, such as a local area network (LAN) or a wide area network (WAN), through many interfaces including dial-in-connections, cable modems and high-speed lines. Alternatively, computer 14 is any device capable of interconnecting to a network including a web-based phone or other web-based connectable equipment. In one embodiment, mainframe 12 includes database server 16 and the database (not shown) is stored on database server 16. In an alternative embodiment database (not shown) is stored remotely from mainframe 12.

FIG. 2 is a block diagram of a network based system 22. System 22 includes mainframe 12 and a server 23 configured as a server sub-system and computers 14. In the embodiment shown, server 23 includes an application server 24, a web server 26, a fax server 28, a database server 29, a directory server 30, and a mail server 32. A disk storage unit 34 is coupled to database server 29 and directory server 30. Servers 24, 26, 28, 29, 30, and 32 are coupled in a local area network (LAN) 36. In addition, a system administrator work station 38, a work station 40, and a supervisor work station 42 are coupled to LAN 36. Alternatively, work stations 38, 40, and 42 are coupled to LAN 36 via an Internet link or are connected through an intranet.

Each work station 38, 40, and 42 is a personal computer including a web browser. Although the functions performed at the work stations typically are illustrated as being performed at respective work stations 38, 40, and 42, such functions can be performed at one of many personal computers coupled to LAN 36. Work stations 38, 40, and 42 are illustrated as being associated with separate functions only to facilitate an understanding of the different types of functions that can be performed by individuals having access to LAN 36.

Mainframe 12 and server 23 are configured to be communicatively coupled to various individuals or employees 44 and to third parties, e.g., users, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than a WAN 50, local area network 36 could be used in place of WAN 50.

In the exemplary embodiment, any employee 44 or user 46 having a work station 52 can access mainframe 12 and server 23. One of computers 14 includes a work station 54 located at a remote location. Work stations 52 and 54 are personal computers including a web browser. Also, work stations 52 and 54 are configured to communicate with mainframe 12 and server 23. Furthermore, fax server 28 communicates with employees 44 and users 46 located outside the business entity and any of the remotely located customer systems, including a customer system 56 via a telephone link. Fax server 28 is configured to communicate with other work stations 38, 40, and 42 as well.

FIG. 3 is a flow chart 100 illustrating processes available to users of wash sale system 10. After a customer logs in 102 to system 22, the system prompts the customer, e.g., via a main menu display that prompts the customer for selection to a type of transaction desired to be completed. The transaction can, for example, be a generation of a number of main reports 106 (described below), an opening balance report 108, a change to a Committee for the Uniform Securities Practices (CUSIP) number 110, a change to a lot number 112 or fund maintenance 114. Of course, the system is not limited to any one specific type of transaction.

User Interfaces

Users of wash sales system 10 have access to the application, typically, and in one embodiment, as an icon on their desktop. Selection of the icon causes a login screen to appear. FIG. 4 is an exemplary example of a user login screen 120 where the user enters their user id and password which has been provided a database administrator. A user id and password are submitted, and system 10 attempts to validate the user id and password.

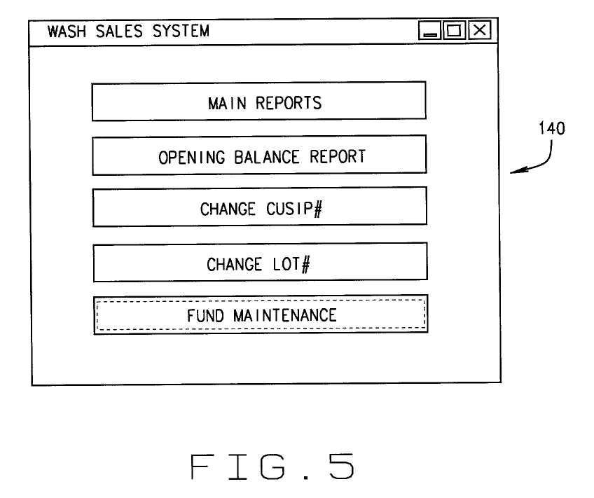

After entry of a valid user id and password, a wash sales main menu will be presented to the user. FIG. 5 is an exemplary example of a main menu screen 140. Main menu screen 140, in one embodiment, is a selection list of options available to the user. Wash sales functions in the embodiment shown in FIG. 5 include a main reports function, an opening balance report function, a change Committee for the Uniform Securities Practices (CUSIP) number function, a change lot number function and a fund maintenance function.

Main Reports

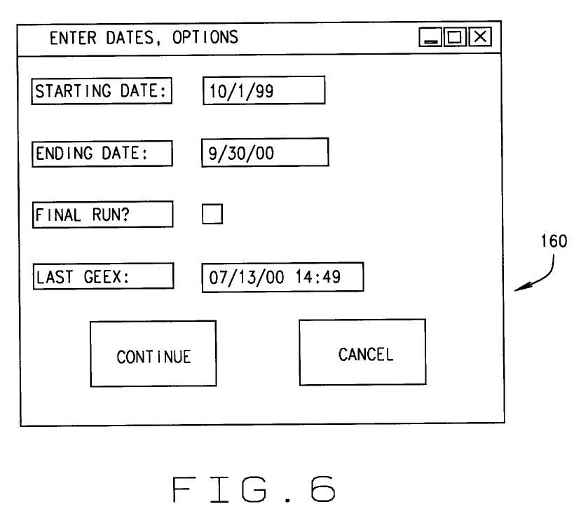

FIG. 6 is an exemplary example of a date range entry screen 160 presented to the user after selection of the main reports function from main menu screen 140 (shown in FIG. 5). Screen 160 is a form presented to the user for date range data entry. Date ranges entered are the date ranges for a fiscal year. For example, if a fiscal year starts on October 1, the starting date entered would be “10/01/yy” and the ending date would be “09/30/yy” of the following year. Upon submission of the selected date range to system 10 (and selection of the funds interested in, described below), a wash sales review and an expired and deferred wash sales report are generated. The user has an option to print one or both of the review and the report.

A “Final Run” option on screen 160, which can be selected by the user, adds deferred wash sales to the history table. Entries into the history table appear on the succeeding year's expired and deferred wash sales report as a “BUY” representing a deferred loss. If such “BUY” is sold in the succeeding year, the deferred loss will be allowed for income tax purposes, otherwise, the deferred loss will remain outstanding.

Text box 162 shows a date and time stamp of the last mainframe trades selection transaction. The user can check this screen periodically to check whether or not the trades selection transaction just submitted has been completed, and the trades are available to be loaded into the server from the mainframe. When the transmission to the server finishes, the latest date and time stamp are displayed on screen 160.

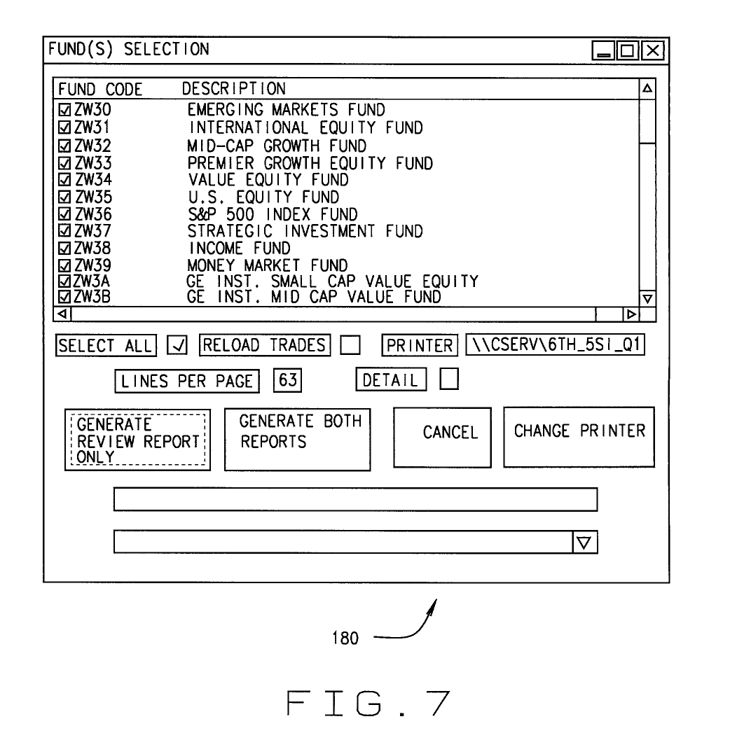

FIG. 7 is an exemplary example of a funds selection screen 180. As stated above, one or more funds for the desired reports can be selected by the user. In one particular embodiment, all funds are selected and funds are deselected by removing a check from a “Select All” checkbox. Then user then manually selects the funds for the report.

A “reload” option on screen 180, if selected, loads the trades from the last trade selection transaction stored on mainframe 12 (shown in FIGS. 1 and 2), including the previously specified date range, and reloads those trades into a trades table within database 18 (shown in FIG. 1). The “reload” option, if not selected, saves the user a considerable amount of time, by not transferring trade files from the mainframe 12 (shown in FIGS. 1 and 2).

A “lines per page” data entry field on screen 180, in one embodiment, is set by system 10, to an appropriate value for the user's printer. Screen 180 offers the user, in one embodiment, choices to either generate only the review report or to generate both the review report and a expired and deferred wash sales report, (both described below) as desired by the user. After creating the reports, the user is presented again with main menu 140 (shown in FIG. 5). In one exemplary embodiment, the reports are made available to the user as an option on a taskbar (not shown), which, by selection opens the report(s) for inspection and/or printing. In one particular embodiment, the reports are automatically saved, in a spreadsheet format, with the names which uniquely identify the reports and which include the dates and times when the reports were created. In another embodiment, the reports can also be saved by the user under file names selected by the user.

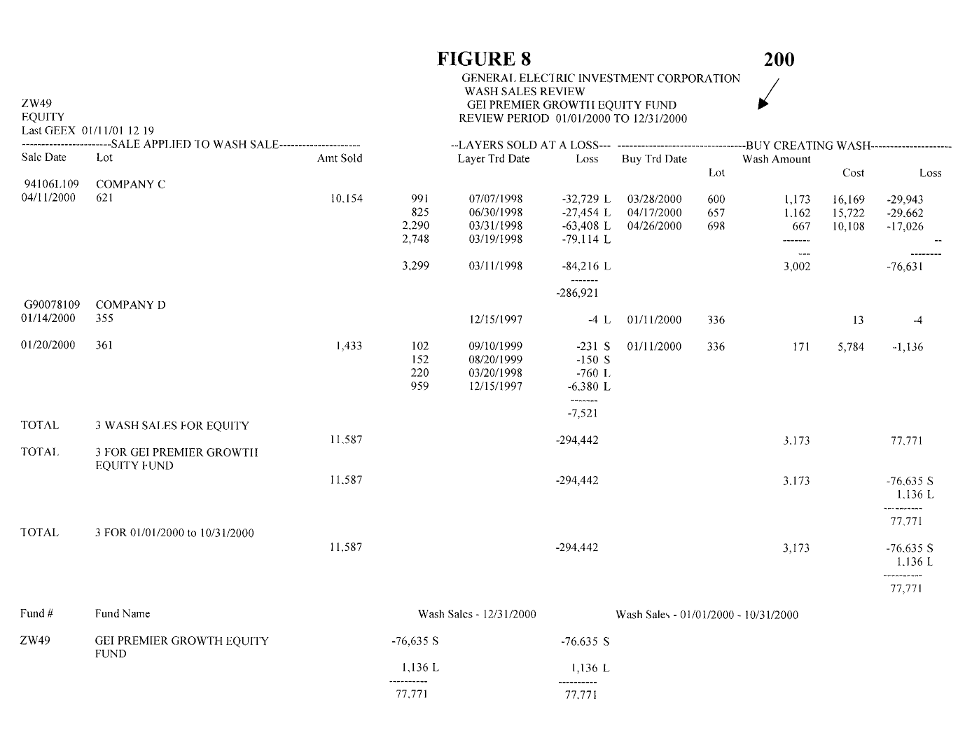

FIG. 8 is an exemplary example of a wash sales review report 200. One embodiment of a wash sales review report, as shown in report 200, contains three headings, “SALE APPLIED TO WASH SALE”, “LAYERS SOLD AT A LOSS”, and “BUY CREATING WASH”. The headings describe a genesis of each of the listed wash sales.

In a “SALE APPLIED TO WASH SALE” transaction, the sale at a loss that is matched with a purchase to create a wash sale is identified. In these cases, a wash sale arises because the investor would have sold stock or securities at a loss that the investor purchased within the 61-day period. The letter “S” in the file extracted from the mainframe 12 (shown in FIGS. 1 and 2) identifies these transactions. The transactions will have occurred within the user-entered date range, possess a user-selected fund code and have at least one qualifying “BUY CREATING WASH” transaction associated with it, which is identified by each of the transactions having the same CUSIP number. If the transaction has a broker code indicating that the sale was a “Redemption in Kind” or a “paydown,” however, it is not a “SALE APPLIED TO WASH SALE” transaction, as no sale would have occurred for tax purposes.

The “LAYERS SOLD AT A LOSS” heading includes details (number of shares, purchase date of lot or layer, and potential wash sale loss) of the lots or layers of the number of shares in an amount sold column under the heading “SALE APPLIED TO WASH SALE”.

In a “BUY CREATING WASH” transaction, a purchase is matched with a sale at a loss to create a wash sale. In these cases, a wash sale arises because the investor would have purchased stock or securities within the 61-day period in which the investor previously sold such stock or securities at a loss. The letter “B” in the file extracted from the mainframe 12 (shown in FIGS. 1 and 2), in one embodiment, identifies these transactions. The transactions will have occurred within the user-entered date range. In addition, the find, asset group and CUSIP number of the stock or securities purchased would match the fund, asset group and CUSIP number of the substantially identical stock or securities sold.

Further, for a “BUY CREATING WASH” transaction of a particular security of a fund, the cost base has to be greater than zero and the fund, asset group, CUSIP number, purchase date and lot number cannot have been party to a wash sale transaction on the most recent final run's review report for the fund. Also, there needs to be at least one layer for the sale, and the layers in question must have a loss.

Cost base is calculated as the cost per share equal to the cost of the total number of shares bought in the lot divided by the number of shares in the lot and zero is used for cost per share if the total number of shares bought equals zero.

If the investor purchases more shares than needed to create a wash sale, then only the shares needed to create the wash sale transaction are listed in a “Wash Amount” column on report 200. In all other cases, the total number of shares purchased will equal the total number of shares listed in the “Wash Amount” column. The “Cost” column in report 200 is the cost base of the number of shares shown in the “Wash Amount”.

System 10 examines the “LAYERS SOLD AT A LOSS” from the oldest to most recent date of purchase. The letter “D” (detail) in the file extracted from the mainframe 12 (shown in FIGS. 1 and 2), in one embodiment, identifies these transactions. For each layer examined, if there are more shares available in the layer then the “Wash Amount”, the “Loss” calculated by system 10 will be equal to the number of shares actually needed multiplied by the loss per share in the layer. If the layer does not have more shares than are needed, then the loss from the layer is calculated as being equal to the total number of shares available in the layer multiplied by the loss per share in the layer. As a result of either calculation, system 10 reduces the number of shares available in the layer by the amount of shares used from the layer, so as to avoid counting these shares in future wash sale transactions. If still more shares are needed for the “Wash Amount,” system 10 repeats the above process using the next most recent layer (if available).

A total loss is calculated for each layer used for the “Wash Amount” and the accumulated loss is displayed (or printed) under the “Loss” column. The system accumulates the loss deferred from each layer in either a “short term” bucket, if the stock or security has not been held for more than 12 months, or a “long term” bucket, if the stock or securities have been held for more than 12 months. System 10 accumulates separate totals for short-term and long-term losses which are needed when the “BUY CREATING WASH” column is written to a file for inclusion on the “EXPIRED AND DEFERRED WASH SALE REPORT” (described below).

If the layer was sold more than 12 months after the layer was purchased, the loss is denoted on report 200 as “L” (Long-term), otherwise the loss is denoted as “S” (Short-term). If the shares traded on the layer is not equal to zero, system 10 calculates an loss per share for the layer equal to the loss on the layer divided by the shares traded on the layer. Otherwise, system 10 is configured to use zero for loss per share. Loss is used in the calculation of loss for “BUY CREATING WASH” transactions.

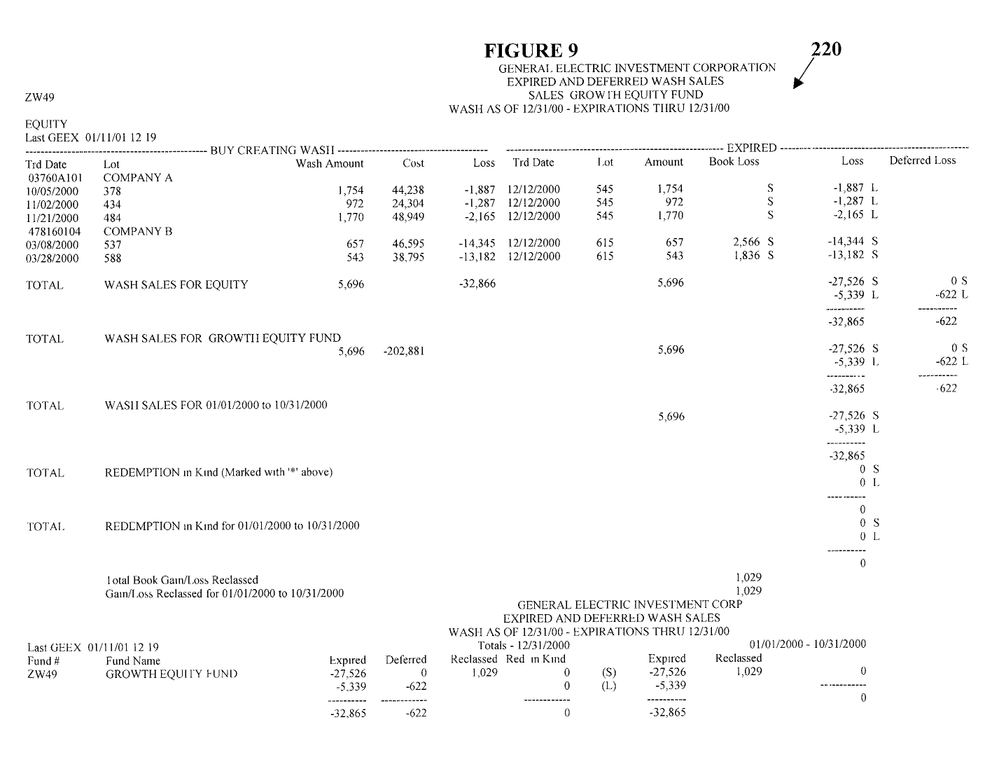

FIG. 9 is an exemplary example of an EXPIRED AND DEFERRED WASH SALE report 220, which includes a “BUY CREATING WASH” heading and an “EXPIRED” heading.

The data shown under the “BUY CREATING WASH” heading, including, trade date, lot, wash amount, cost, loss, is traceable to the data under the “BUY CREATING WASH” heading on the current “WASH SALE REVIEW” report 200 (shown in FIG. 8) and the deferred wash sales from the previous year's “EXPIRED AND DEFERRED WASHSALES” report, if applicable.

If further details are necessary, the user would select “SELL” and “PAYD” type “D” (“Detail”) transactions from the transaction data in the mainframe 12 (shown in FIGS. 1 and 2) which match the purchased stock or securities by fund code, asset group, CUSIP, lot number, and purchase date. The trade date must be within the range of dates entered by the user to be selected. These transactions are the pool from which the expirations are selected and printed.

For each purchase that creates a wash sale (a transaction found under the heading “BUY CREATING WASH”), system 10 gathers all of the matching layers from the current “WASH SALE REVIEW REPORT” or the previous year's deferred wash sales (whichever is applicable). To qualify, the layers must all have shares which were not used from those layers toward the “Buy Creating Wash” on the review report. The layers are used for calculating the loss on the expirations only, and are not included on this report.

If the total of the shares traded on the layer is not equal to zero, system 10 calculates an loss per share for the layer equal to the loss on the layer divided by the total number of shares traded on the layer; otherwise, it uses zero for the loss per share. The loss is used in the calculation of the loss for under the “EXPIRED” heading.

System 10 is further configured to examine the expirations for the “buy,” starting with the earliest. If there are still shares available from the prior year that are shown in the expiration report to apply against the “buy”, system 10 will determine as many shares as it needs from the expiration under “Amount” and include that number of shares on report 220 and in printouts of the reports. If all of the shares in the expiration column are needed, system 10 will use all of the shares in the calculation. For example, shares from an expiration may only be used once, i.e., 100 shares used from expiration “A” may be used against purchase “A” but may not be used again for purchase “B”.

System 10 further calculates the loss on the shares for each expiration by looping through the layers, starting with the earliest. If a layer has shares that are still available (i.e., have not yet been allocated to another expiration), system 10 is configured to use as many of the shares as needed for the expiration. For the number of shares used from each layer, system 10 calculates the loss on those shares by multiplying the number of shares used from the layer by the loss per share that was previously calculated for the layer. System 10 also calculates totals for the number of shares used from all layers for the expiration, as well as the total loss on those shares from all layers for the expiration. These totals are displayed (and printed) under the “Amount” and “Loss” columns. The amount of shares available from each layer is reduced by the amount used. Therefore, shares from a layer may not be used for more than one expiration.

A determination of how much of the expiration's loss is short term and how much is long term by system 10 is determined for each layer used. For example, if the purchase date appearing on the original “wash sales review report” (i.e., the review report on which the “buy creating wash” originally appeared) is not greater than the sale date appearing on that report, then system 10 calculates the number of days between the expiration sale date and the layer's purchase date used in the loss calculation. In other cases, system 10 calculates a number of days between the layer's purchase date and the original sale date on the review report and adds to it the difference between the original purchase date on the review report and the expiration sale date.

In either case, if the number of days calculated is less than 365 then it is short term (“S”), otherwise it is long-term (“L”). It is possible that one or more layers for an expiration sale could be “S” and one or more other layers “L”, depending on the original sale date from the original review report. When this situation occurs, the amount of loss for each type is shown on report 220.

The above descriptions are more easily illustrated by example.

A first example is a purchase which created the wash sale has a purchase date earlier than the layer's sale date, where the original purchase date of the layer sold is Oct. 5, 1998, the purchase date of purchase which created the wash sale is Dec. 1, 1999, the sale date of the layer which occurred within 30 days (before or after) of the purchase date is Dec. 15, 1999, and the date when the Dec. 01, 1999 purchase was sold (also known as the expiration sale date) is Jan. 31, 2000.

Since the Dec. 1, 1999 purchase date occurs before the layer's Dec. 15, 1999 sale date, system 10 calculates a difference in days between Jan. 31, 2000 and Oct. 5, 1998. Since the difference is clearly more than 365 days, the loss on this layer is Long-Term (“L”).

A second example is a purchase which created the wash sale has a purchase date later than the layer's sale date, where the original purchase date of layer sold is Oct. 5, 1998, the purchase date of purchase which created the wash sale is Dec. 20, 1999, the sale date of layer which occurred within 30 days (before or after) of the purchase date is Dec. 15, 1999, and the date when the Dec. 20, 1999 purchase was sold (also known as the expiration sale date) is Jan. 31, 2000.

Since the Dec. 20, 1999 purchase date occurs after the layer's Dec. 15, 1999 sale date, system 10 calculates a difference in days between Oct. 5, 1998 and Dec. 15, 1999 and adds that difference to the difference between Dec. 20, 1999 and Jan. 31, 2000. The difference in days between Dec. 15, 1999 and Dec. 20, 1999 is not included because the stock was not held during this period of time. Since the total difference is clearly more than 365 days, the loss on this layer is still Long-Term (“L”).

On report 220, in one embodiment, if the broker code for the expiration is for a “redemption in kind”, an asterisk “*” will appear next to the loss-type indicator. A “book loss” shown on report 220 is a pro-rated, calculated amount equal to the ratio of the amount of shares expired (i.e., used) for the expiration over the total number of shares sold, multiplied by the book loss associated with the total number of shares sold.

If the amount of stock or securities sold is less than the amount purchased, then a wash sale occurs. In these cases, system 10 creates a “Deferred Loss” amount equal to the amount of the wash sale. Technically, the system compares the expired amount total for any “BUY CREATING WASH” (shown on report 220) to the “Wash Amount” for the “buy.” If the former is less than the latter, then a “deferred loss” equal to the difference between the loss on the “BUY CREATING WASH” and the calculated loss total on the associated expirations is created. Alternatively, if there are no expirations for the “BUY CREATING WASH”, then the “Deferred Loss” is equal to the loss on the “BUY CREATING WASH”.

For example, if expiration sale dates are between January 1 and October 31 (for funds with a fiscal year-ending date of December 31st ) or between October 1 and October 31 (for funds with a fiscal year-ending date of September 30th ), then fund totals for these expiration amounts and calculated losses (split by loss type) are shown on report 220. If any expirations are for “redemptions in kind”, then fund totals for these calculated losses (split by loss type, long term or short term) are shown on report 220. If there is a “Deferred Loss,” any layers with available shares remaining are saved to a wash sales file with the data from the “BUY CREATING WASH” section. The “BUY CREATING WASH” data will appear on next year's “EXPIRED AND DEFERRED WASH SALES” report for these funds; the available shares from the layers will be used to calculate the loss for any expirations (if any) which appear on the same report.

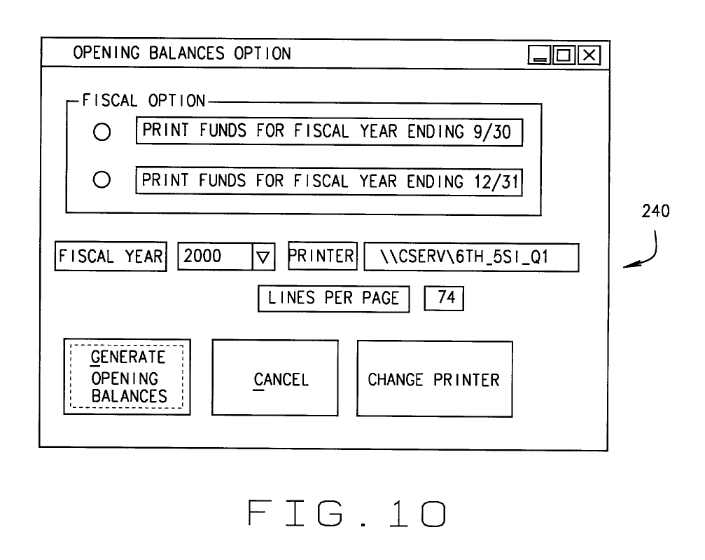

FIG. 10 is an exemplary example of an opening balances report selection screen 240 which permits the user to select a particular set of funds on which a report will be run, for example, funds ending on September 30 or December 31. Screen 240 also shows the years for which historical data on the funds is available. Also on screen 240, selection of “generate opening balances” creates a spreadsheet for the report.

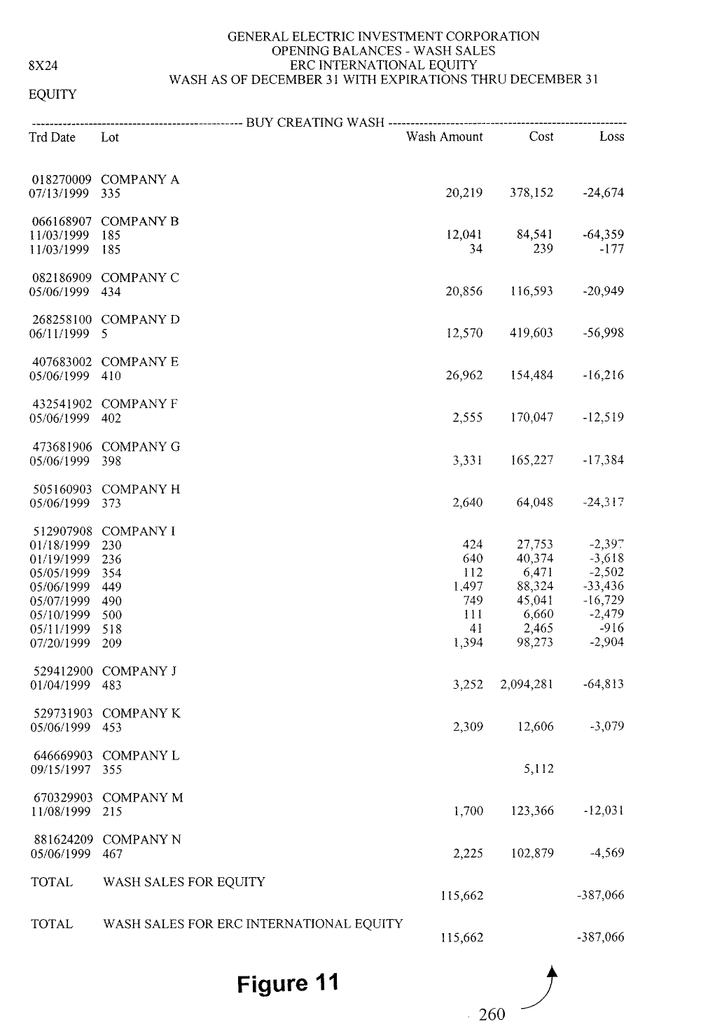

FIG. 11 is an exemplary example of an opening balances report 260, which includes all of the deferred “BUY CREATING WASH” amounts which appeared on the final run of the “EXPIRED AND DEFERRED WASH SALE” report for the year and set of funds selected by the user.

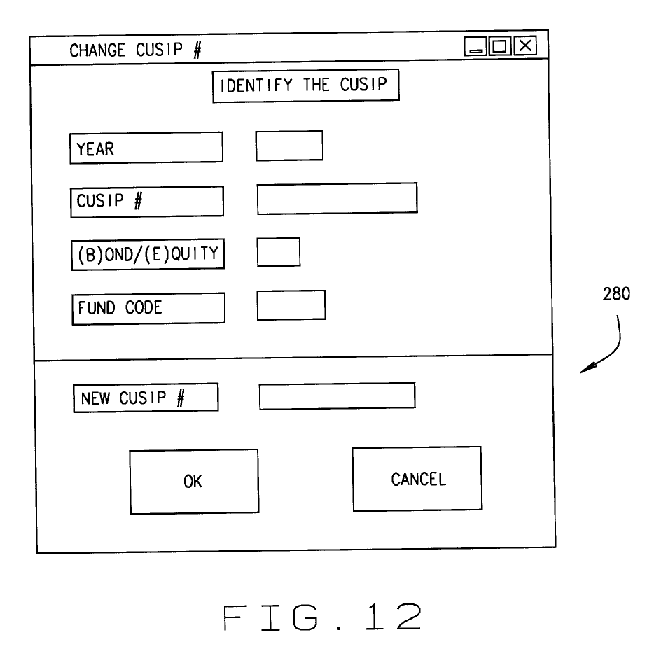

FIG. 12 is an exemplary example of a change CUSIP (Committee for the Uniform Securities Practices) number screen 280 which allows a user to change a CUSIP number within a history table (i.e., the cumulative unexpired and deferred wash sales tables). To change a CUSIP number, the user needs to specify a year, the CUSIP number, an asset group and the fund code of the lot(s) to be changed, as well as provide the a new CUSIP number. If the CUSIP specified is not in the history table, system 10 indicates an error. If at least one matching record is found, system 10 indicates how many records were changed.

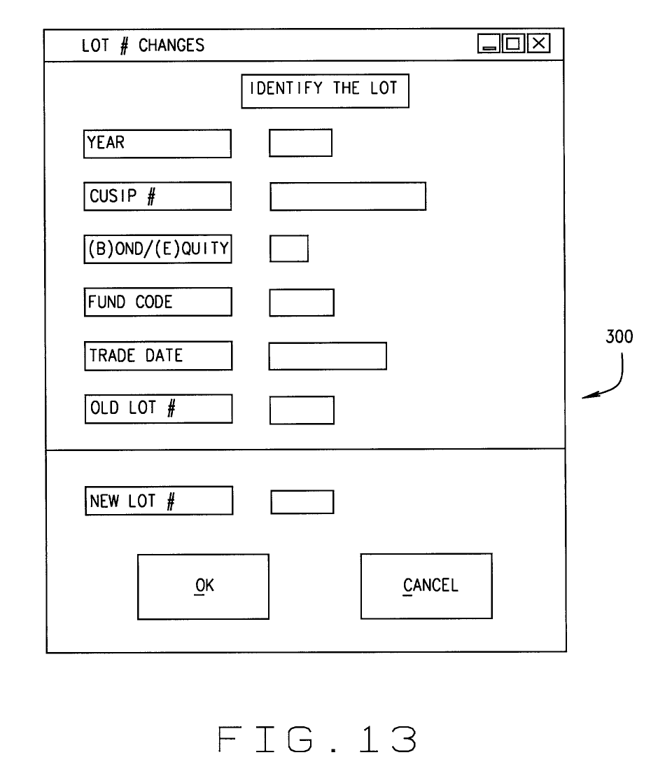

FIG. 13 is an exemplary example of a lot number changes screen 300 which allows the user to change a lot number within a history table. To change a lot number, the user needs to specify a year, a CUSIP number, an asset group, a fund code, a trade date and the lot number of the lot to be changed, as well as a new lot number. If the lot number to be changed is not in the table, system 10 indicates an error. If at least one matching record is found, system 10 indicates how many records were changed.

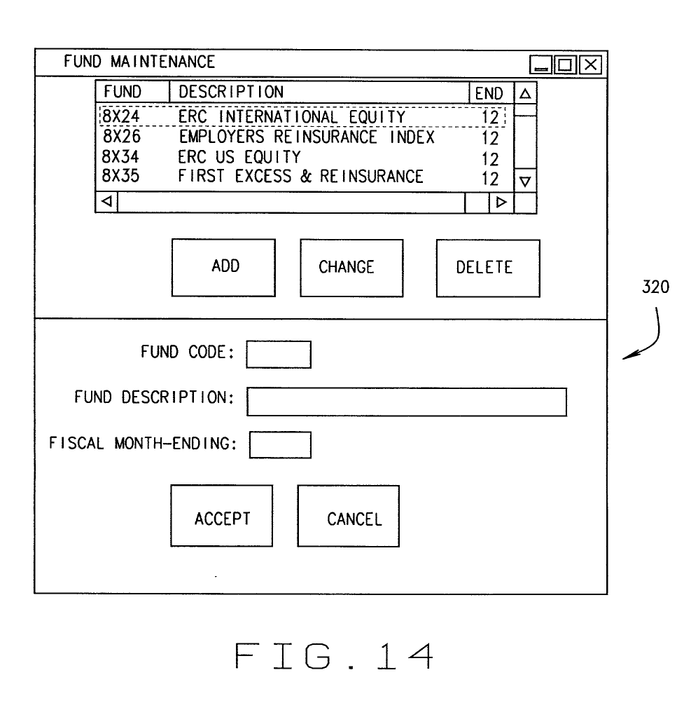

FIG. 14 is an exemplary example of a fund maintenance screen 320 which allows a user to add new funds, change a fund description and/or fiscal-ending month, or delete a fund. Changes to a fund description, in one embodiment, is accomplished by highlighting the existing fund description and/or fiscal-ending month, selecting “change”, entering a new description in an appropriate data field and then selecting “update”.

To delete a fund, the user highlights the fund and then selects “delete”. System 10 displays the current fund descriptive data. A second selection of “delete” to confirms the deletion. To add a fund, select “add”, enter the data for the new fund in the appropriate data fields and select “add” again. Additions, changes, or deletions are uploaded to the mainframe for use in the next trade transaction.

While the invention has been described in terms of various specific embodiments, those skilled in the art will recognize that the invention can be practiced with modification within the spirit and scope of the claims.

What is claimed is:

1. A method for tracking purchases and sales of securities to determine gains or losses on the securities, said method comprising the steps of:
creating a database of securities purchases;
adding sales of the securities to the database; and
comparing a sales date to a purchase date for each individual security.

2. A method according to claim 1 further comprising the step of providing a list of securities sales that resulted in a loss.

3. A method according to claim 2 wherein said step of providing a list of securities sales that resulted in a loss further comprises the step of preparing a wash sales review report.

4. A method according to claim 3 wherein said step of preparing a wash sales review report further comprises the step of showing sales applied to the wash sale, buys that created the wash and the layers of securities sold at a loss.

5. A method according to claim 3 wherein said step of preparing a wash sales review report further comprises the step of determining a date range for the securities purchases and sales.

6. A method according to claim 3 wherein said step of preparing a wash sales review report further comprises the step of determining if the sale of securities was classified as at least one of a redemption in kind or a paydown.

7. A method according to claim 3 wherein said step of preparing a wash sales review report further comprises the step of determining if the purchase of securities and the sale of securities have at least one of a common fund, a common asset group and CUSIP number.

8. A method according to claim 3 wherein said step of preparing a wash sales review report further comprises the step of determining if the purchase of securities was within 30 days, before or after, the sale of the securities.

9. A method according to claim 3 wherein said step of preparing a wash sales review report further comprises the step of determining if the purchased securities has a cost base of greater than zero.

10. A method according to claim 1 wherein said step of comparing a sales price to a purchase price for each individual security further comprises the step of using only a number of shares from a buy creating a wash needed to meet a number of shares traded in a first sale applied to the wash sale.

11. A method according to claim 10 further comprising the step of reducing a number of shares available in a buy creating a wash for a second sale applied to a wash sale when the number of shares in the buy creating the wash is greater then the number needed in the first sale applied to the wash sale.

12. A method according to claim 1 further comprising the step of accumulating separate totals for short-term losses and long-term losses, where long term is defined as a sale more than 12 months after a purchase of the same security.

13. A method according to claim 2 wherein said step of providing a list of securities sales that resulted in a loss further comprises the step of preparing an expired and deferred wash sales report.

14. A method according to claim 13 wherein said step of preparing an expired and deferred wash sales report further comprises the step of selecting type “D” (detail) transactions which match the buy creating wash by at least one of fund code, asset group, CUSIP number, lot number and purchase date.

15. A method according to claim 14 further comprising the step of matching layers from a current wash sale review report or a previous year's deferred wash sales for each buy creating a wash.

16. A method according to claim 15 further comprising the step of using the matching layers, which contain a number of shares and an amount of loss, to calculate a loss on expirations.

17. A method according to claim 16 further comprising the step of examining expirations to determine if any of the shares are still available to apply against a buy.

18. A method according to claim 1 further comprising the step of compiling an opening balances report which includes all deferred buys creating washes.

19. A method according to claim 1 further comprising the step of performing fund maintenance.

20. A method according to claim 19 wherein said step of performing fund maintenance further comprises the step of at least one of adding new funds, changing fund descriptions, changing a fiscal ending month and deleting funds.

21. A system for tracking purchases and sales of securities to determine gains or losses on the securities comprising:
at least one computer;
a mainframe which includes a database of securities purchases;
a server capable to connecting to said mainframe; and
a network interconnecting said computer, said mainframe and said server, said server configured with a database to store records of purchases and sales of the securities downloaded from said mainframe and to compare a sales date to a purchase date for each individual security.

22. A system according to claim 21 wherein said server configured to provide a list of securities sales that resulted in a loss.

23. A system according to claim 22 wherein said server configured to prepare a wash sales review report.

24. A system according to claim 23 wherein said server configured to show sales applied to the wash sale, buys that created the wash and the layers of securities sold at a loss.

25. A system according to claim 23 wherein said server configured to prepare a wash sales review report over a user selected date range for the securities purchases and sales.

26. A system according to claim 23 wherein said server configured to determine if the sale of securities was classified as a redemption in kind or as a paydown.

27. A system according to claim 23 wherein said server configured to determine if the purchase of securities and the sale of securities have at least one of a common fund, a common asset group and CUSIP number.

28. A system according to claim 23 wherein said server configured to determine if the purchase of securities was within 30 days, before or after, of the sale of the securities.

29. A system according to claim 23 wherein said server configured to determine if a purchase of securities has a cost base of greater than zero.

30. A system according to claim 21 wherein said server configured to determine a number of shares from a buy creating a wash needed to meet a number of shares traded in a first sale applied to the wash sale.

31. A system according to claim 30 wherein said server configured to reduce a number of shares available in a buy creating a wash for a second sale applied to a wash sale when the number of shares in the buy creating the wash is greater than the number needed in the first sale applied to the wash sale.

32. A system according to claim 21 wherein said server configured to accumulate separate totals for short-term losses and long-term losses, where long term is defined as a sale more than 12 months after a purchase of the same security.

33. A system according to claim 22 wherein said server configured to prepare an expired and deferred wash sales report.

34. A system according to claim 33 wherein said server configured to select type “D” (detail) transactions which match the buy creating wash by at least one of fund code, asset group, CUSIP number, lot number and purchase date.

35. A system according to claim 34 wherein said server configured to match layers from a current wash sale review report or a previous year's deferred wash sales for each buy creating a wash.

36. A system according to claim 35 wherein said server configured to use the matching layers, which contain a number of shares and an amount of loss, to calculate a loss on expirations.

37. A system according to claim 36 wherein said server configured to examine expirations to determine if any of the shares are still available to apply against a buy.

38. A system according to claim 21 wherein said server configured to compile an opening balances report which includes all deferred buys creating washes.

39. A system according to claim 21 wherein said server configured with a fund maintenance function.

40. A system according to claim 39 wherein said server configured to allow a user to do at least one of adding new funds, change fund descriptions, change a fiscal ending month and deleting funds.

41. A system according to claim 40 wherein said server configured to upload at least one of additions, changes and deletions to fund to said database within said mainframe.

42. A system according to claim 21 wherein said server configured to allow a user to change a CUSIP number on unexpired and cumulative wash sales by specifying at least one of a year, an asset group and a fund code, as well as the CUSIP number to be changed and a new CUSIP number.

43. A system according to claim 21 wherein said server configured to allow a user to change a lot number by specifying at least one of a year, a CUSIP number, an asset group, a fund code and a trade date, as well as the lot number of the lot to be changed and a new lot number.

44. A method for operating a computer to facilitate tracking of wash sales, said method comprising the steps of:
prompting a user to enter a starting date and an ending date for purchases and sales;
prompting a user to select at least one fund for desired reports; and
generating at least one of a wash sales review report and an expired and deferred wash sales report.

45. A method according to claim 44 wherein said step of generating a report comprises the step of prompting a user to print the report.

46. A method according to claim 44 wherein generating a wash sales review report comprises generating at least one of sales applied to wash sales, layers sold at a loss, and buys creating washes.

47. A method according to claim 44 wherein generating an expired and deferred wash sales report comprises generating at least one of buys creating washes and expired sales and purchases.

48. A method according to claim 44 wherein said step of generating a report comprises the step of determining if a transaction was at least one of a redemption in kind and a paydown.

49. A method according to claim 44 further comprising the step of prompting the user to prepare an opening balances report.

50. A method according to claim 49 further comprising the step of prompting a user to select a fiscal year for the opening balances report.

51. A method according to claim 44 further comprising the step of prompting the user to select at least one of change CUSIP numbers, change lot numbers and perform fund maintenance.

52. A computer programmed to:
prompt a user to enter a starting date and an ending date for purchases and sales;
prompt a user to select at least one fund for desired reports; and
generate at least one of a wash sales review report and an expired and deferred wash sales report.

53. A computer according to claim 52 wherein to generate a report, said computer displays a computer generated screen listing a print option for printing the report.

54. A computer according to claim 52 wherein in generating a wash sales review report, said computer displays a computer generated screen listing at least one of sales applied to wash sales, layers sold at a loss, and buys creating washes.

55. A computer according to claim 52 wherein in generating an expired and deferred wash sales report, said computer displays a computer generated screen listing at least one of buys creating washes and expired sales and purchases.

56. A computer according to claim 52 wherein in generating a report, said computer displays a computer generated screen listing if a transaction was at least one of a redemption in kind and a paydown.

57. A computer according to claim 52 further programmed to display a computer generated screen listing an opening balances report option.

58. A computer according to claim 57 configured to prompt a user to select a fiscal year for the opening balances report.

59. A computer according to claim 52 configured to display a computer generated screen prompting a user to select at least one of change CUSIP numbers, change lot numbers and perform fund maintenance.

60. A computer according to claim 52 wherein to prompt a user to select at least one fund for desired reports, said computer displays a computer generated screen prompting the user whether to reload trades from a mainframe.

61. A computer according to claim 52 configured to determine to whether the sale and purchase of securities creating a wash is one of long-term or short-term.

62. A database comprising:
data corresponding to sale dates and purchase dates for a selected group of funds of securities; and
data corresponding to gains and losses on the sales and purchases of the funds; and
data corresponding to a comparison of purchase dates and sale dates for each security within the fund.

63. A database according to claim 62 further comprising data corresponding to at least one of buys creating washes, sales applied to wash sales, layers sold at a wash and expired wash sales.

64. A database according to claim 62 further comprising data corresponding to at least one of a CUSIP number and a lot number for each fund.

65. A database according to claim 62 further comprising data corresponding to whether the sale and purchase of securities creating a wash is one of long-term or short-term.

66. A method for tracking of wash sales, said method comprising the steps of:
selecting, from an electronic interface, a starting date and an ending date for purchases and sales;
selecting, from an electronic interface, at least one fund for desired reports; and
requesting, from the electronic interface, at least one of a wash sales review report and an expired and deferred wash sales report.

67. A method according to claim 66 wherein the wash sales review report comprises at least one of sales applied to wash sales, layers sold at a loss, and buys creating washes.

68. A method according to claim 66 wherein the expired and deferred wash sales report comprises at least one of buys creating washes and expired sales and purchases.

69. A method according to claim 66 further comprising the step of requesting, from the electronic user interface, an opening balances report.

70. A method according to claim 69 further comprising the step of selecting, from the electronic user interface, a fiscal year for the opening balances report.

71. A method according to claim 66 further comprising the step of selecting, from the electronic user interface, at least one of change CUSIP numbers, change lot numbers and perform fund maintenance.
